(19) United States
(12) Patent Application Publication
(10) Pub. No.: US 2023/0289580 A1
(43) Pub. Date: Sep. 14, 2023

(54) NEURAL NETWORK CIRCUIT AND NEURAL NETWORK CIRCUIT CONTROL METHOD

(71) Applicant: LeapMind Inc., Tokyo (JP)

(72) Inventor: Koumei TOMIDA, Tokyo (JP)

(21) Appl. No.: 18/019,365

(22) PCT Filed: Feb. 16, 2021
(86) PCT No.: PCT/JP2021/005610

§ 371 Date: Feb. 2, 2023

(30) Foreign Application Priority Data
Aug. 7, 2020 (JP) 2020-134562

(51) Int. Cl. G06N 3/063; G06F 9/38

(52) U.S. Cl. CPC G06N 3/063; G06F 9/3842

(57) ABSTRACT

A neural network circuit comprising a convolution operation circuit that performs a convolution operation on input data; a quantization operation circuit that performs a quantization operation on convolution operation output data from the convolution operation circuit; and a command fetch unit that reads, from an external memory, commands for operating the convolution operation circuit or the quantization operation circuit.

### TECHNICAL FIELD

The present invention relates to a neural network circuit and a neural network circuit control method.

### BACKGROUND ART

In recent years, convolutional neural networks (CNN) have been used as models for image recognition and the like. Convolutional neural networks have a multilayered structure with convolutional layers and pooling layers, and require many operations such as convolution operations. Various operation processes that accelerate operations by convolutional neural networks have been proposed (e.g., Patent Document 1).

### CITATION LIST

### Patent Documents

[Patent Document 1] JP 2018-077829 A

### SUMMARY OF INVENTION

### Technical Problem

Meanwhile, there is a demand to implement image recognition and the like by utilizing convolutional neural networks in embedded devices such as loT devices. Large-scale dedicated circuits as described in Patent Document 1 are difficult to embed in embedded devices. Additionally, in embedded devices with limited hardware resources such as CPU or memory, sufficient operational performance is difficult to realize in convolutional neural networks by means of software alone.

In consideration of the above-mentioned circumstances, the present invention has the purpose of providing a neural network circuit that operates with high performance and that is embeddable in an embedded device such as an IoT device, and a control method for the neural network circuit.

### Solution to Problem

In order to solve the above-mentioned problems, the present invention proposes the features indicated below.

The neural network circuit according to a first aspect of the present invention comprises a convolution operation circuit that performs a convolution operation on input data; a quantization operation circuit that performs a quantization operation on convolution operation output data from the convolution operation circuit; and a command fetch unit that reads, from an external memory, commands for operating the convolution operation circuit or the quantization operation circuit.

The neural network circuit control method according to a second aspect of the present invention is a control method for a neural network circuit comprising a convolution operation circuit that performs a convolution operation on input data, a quantization operation circuit that performs a quantization operation on convolution operation output data from the convolution operation circuit, and a command fetch unit that reads, from a memory, commands for operating the convolution operation circuit or the quantization operation circuit, wherein the neural network circuit control method includes a step of making the command fetch unit read the command from the memory and supply the command to the convolution operation circuit or the quantization operation circuit; and a step of making the convolution operation circuit or the quantization operation circuit operate based on the command that was supplied.

### Advantageous Effects of Invention

The neural network circuit of the present invention operates with high performance and is embeddable in an embedded device such as an loT device. The neural network circuit control method of the present invention can improve the operation processing performance of the neural network circuit.

### BRIEF DESCRIPTION OF DRAWINGS

FIG. 1 is a diagram illustrating a convolutional neural network.

FIG. 2 is a diagram for explaining convolution operations performed by convolution layers.

FIG. 3 is a diagram for explaining data expansion in a convolution operation.

FIG. 4 is a diagram illustrating the overall structure of a neural network circuit according to a first embodiment.

FIG. 5 is a timing chart indicating an operational example of the neural network circuit.

FIG. 6 is a timing chart indicating another operational example of the neural network circuit.

FIG. 7 is a diagram illustrating dedicated wiring connecting an IFU in a controller in the neural network circuit with a DMAC, etc.

FIG. 8 is a state transition diagram of a control circuit in the DMAC.

FIG. 9 is a diagram explaining control of the neural network circuit by semaphores.

FIG. 10 is a timing chart of first data flow.

FIG. 11 is a timing chart of second data flow.

### DESCRIPTION OF EMBODIMENTS

### First Embodiment

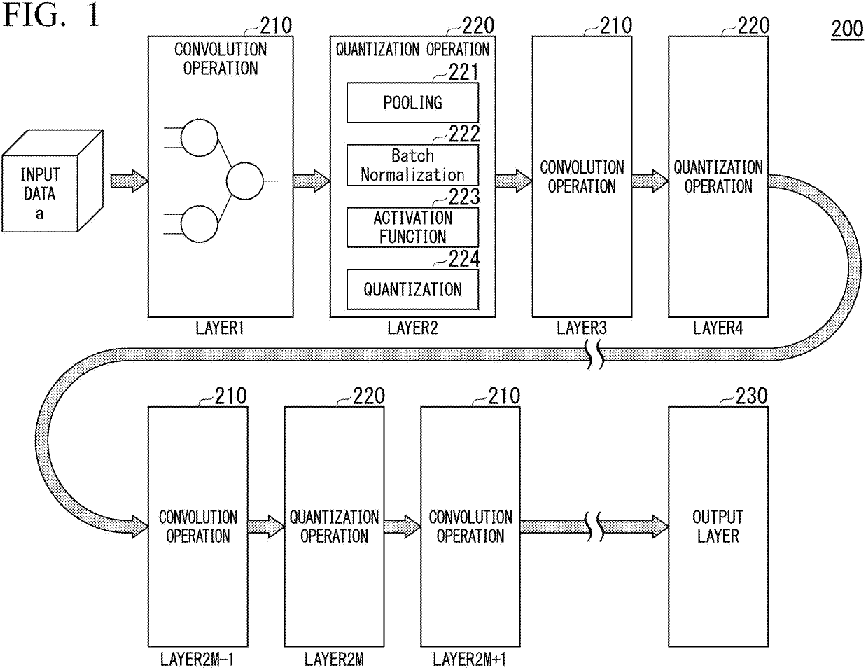

A first embodiment of the present invention will be explained with reference to FIG. 1 to FIG. 11.

FIG. 1 is a diagram illustrating a convolutional neural network 200 (hereinafter referred to as “CNN 200”). The operations performed by the neural network circuit 100 (hereinafter referred to as “NN circuit 100”) according to the first embodiment constitute at least part of a trained CNN 200, which is used at the time of inference.

### [CNN 200]

The CNN 200 is a network having a multilayered structure, including convolution layers 210 that perform convolution operations, quantization operation layers 220 that perform quantization operations, and an output layer 230. In at least part of the CNN 200, the convolution layers 210 and the quantization operation layers 220 are connected in an alternating manner. The CNN 200 is a model that is widely used for image recognition and video recognition. The CNN 200 may further have a layer with another function, such as a fully connected layer.

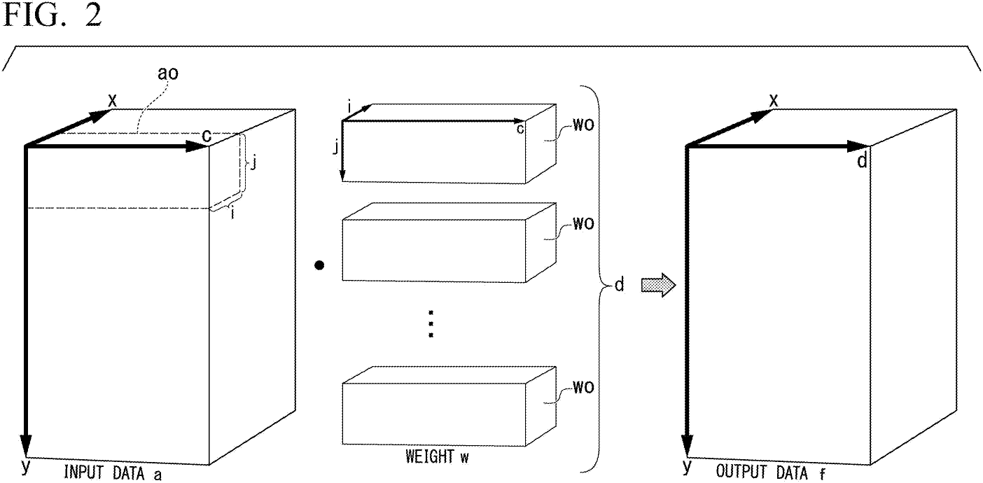

FIG. 2 is a diagram for explaining convolution operations performed by the convolution layer 210.

The convolution layers 210 perform convolution operations in which weights w are used on input data a. When the input data a and the weights w are input, the convolution layers 210 perform multiply-add operations.

The input data a (also referred to as activation data or a feature map) that is input to the convolution layers 210 is multi-dimensional data such as image data. In the present embodiment, the input data a is a three-dimensional tensor comprising elements (x, y, c). The convolution layers 210 in the CNN 200 perform convolution operations on low-bit input data a. In the present embodiment, the elements of the input data a are 2-bit unsigned integers (0, 1, 2, 3). The elements of the input data a may, for example, be 4-bit or 8-bit unsigned integers.

If the input data that is input to the CNN 200 is of a type different from that of the input data a input to the convolution layers 210, e.g., of the 32-bit floating-point type, then the CNN 200 may further have an input layer for performing type conversion or quantization in front of the convolution layers 210.

The weights w (also referred to as filters or kernels) in the convolution layers 210 are multi-dimensional data having elements that are learnable parameters. In the present embodiment, the weights w are four-dimensional tensors comprising the elements (i,j, c, d). The weights w include d three-dimensional tensors (hereinafter referred to as “weights wo”) having the elements (i,j, c). The weights w in a trained CNN 200 are learned data. The convolution layers 210 in the CNN 200 use low-bit weights w to perform convolution operations. In the present embodiment, the elements of the weights w are 1-bit signed integers (0, 1), where the value “0” represents +1 and the value “1” represents -1.

The convolution layers 210 perform the convolution operation indicated in Equation 1 and output the output data f. In Equation 1, s indicates a stride. The region indicated by the dotted line in FIG. 2 indicates one region ao (hereinafter referred to as “application region ao”) in which the weights wo are applied to the input data a. The elements of the application region ao can be represented by (x + i, y + j, c).

$$f \left(x , y , d\right) = {\sum }_{i}^{K} {\sum }_{j}^{K} {\sum }_{c}^{C} a \left(s ⋅ x + i , s ⋅ y + j , c\right) ⋅ w \left(i , j , c , d\right) \qquad \text{[Equation 1]}$$

The quantization operation layers 220 implement quantization or the like on the convolution operation outputs that are output by the convolution layers 210. The quantization operation layers 220 each have a pooling layer 221, a batch normalization layer 222, an activation function layer 223, and a quantization layer 224.

The pooling layer 221 implements operations such as average pooling (Equation 2) and max pooling (Equation 3) on the convolution operation output data f output by a convolution layer 210, thereby compressing the output data f from the convolution layer 210. In Equation 2 and Equation 3, u indicates an input tensor, v indicates an output tensor, and T indicates the size of a pooling region. In Equation 3, max is a function that outputs the maximum value of u for combinations of i and j contained in T.

$$v \left(x , y , c\right) = \frac{1}{{T}^{2}} {\sum }_{i}^{T} {\sum }_{j}^{T} u \left(T ⋅ \text{x} \text{+} i , T ⋅ y + j , c\right) \qquad \text{[Equation 2]}$$

$$v \left(x , y , c\right) = max \left(u \left(T ⋅ x + i , T ⋅ y + j , c\right)\right) , i ∈ T , j ∈ T \qquad \text{[Equation 3]}$$

The batch normalization layer 222 normalizes the data distribution of the output data from a quantization operation layer 220 or a pooling layer 221 by means of an operation as indicated, for example, by Equation 4. In Equation 4, u indicates an input tensor, v indicates an output tensor, a indicates a scale, and β indicates a bias. In a trained CNN 200, α and β are learned constant vectors.

$$v \left(x , y , c\right) = \text{α} \left(c\right) ⋅ \left(u \left(x , y , c\right) - β \left(c\right)\right) \qquad \text{[Equation 4]}$$

The activation function layer 223 performs activation function operations such as ReLU (Equation 5) on the output from a quantization operation layer 220, a pooling layer 221, or a batch normalization layer 222. In Equation 5, u is an input tensor and v is an output tensor. In Equation 5, max is a function that outputs the argument having the highest numerical value.

$$v \left(x , y , c\right) = max \left(0 , u \left(x , y , c\right)\right) \qquad \text{[Equation 5]}$$

The quantization layer 224 performs quantization as indicated, for example, by Equation 6, on the outputs from a pooling layer 221 or an activation function layer 223, based on quantization parameters. The quantization indicated by Equation 6 reduces the bits in an input tensor u to two bits. In Equation 6, q(c) is a quantization parameter vector. In a trained CNN 200, q(c) is a trained constant vector. In Equation 6, the inequality sign “≤” may be replaced with “<”.

$$q t z \left(x , y , c\right) = \begin{matrix}0 i f u \left(x , y , c\right) ≦ q \left(c\right) . t h 0 e l s e \\ 1 i f u \left(x , y , c\right) ≦ q \left(c\right) . t h 1 e l s e \\ 2 i f u \left(x , y , c\right) ≦ q \left(c\right) . t h 0 e l s e \\ 3\end{matrix} \qquad \text{[Equation 6]}$$

The output layer 230 is a layer that outputs the results of the CNN 200 by means of an identity function, a softmax function or the like. The layer preceding the output layer 230 may be either a convolution layer 210 or a quantization operation layer 220.

In the CNN 200, quantized output data from the quantization layers 224 are input to the convolution layers 210. Thus, the load of the convolution operations by the convolution layers 210 is smaller than that in other convolutional neural networks in which quantization is not performed.

### [Partitioning of Convolution Operations]

The NN circuit 100 performs operations by partitioning the input data to the convolution operations (Equation 1) in the convolution layers 210 into partial tensors. The partitioning method and the number of partitions of the partial tensors are not particularly limited. The partial tensors are formed, for example, by partitioning the input data a(x + i, y + j, c) into a(x + i, y + j, co). The NN circuit 100 can also perform operations on the input data to the convolution operations (Equation 1) in the convolution layers 210 without partitioning the input data.

When the input data to a convolution operation is partitioned, the variable c in Equation 1 is partitioned into blocks of size Bc, as indicated by Equation 7. Additionally, the variable d in Equation 1 is partitioned into blocks of size Bd, as indicated by Equation 8. In Equation 7, co is an offset, and ci is an index from 0 to (Bc - 1). In Equation 8, do is an offset, and di is an index from 0 to (Bd - 1). The size Bc and the size Bd may be the same.

$$c = c o ⋅ B c + c i \qquad \text{[Equation 7]}$$

$$d = d o ⋅ B d + d i \qquad \text{[Equation 8]}$$

The input data a(x + i, y + j, c) in Equation 1 is partitioned into the size Bc in the c-axis direction and is represented as the partitioned input data a(x + i, y + j, co). In the explanation below, input data a that has been partitioned is also referred to as “partitioned input data a”.

The weight w(i, j, c, d) in Equation 1 is partitioned into the size Bc in the c-axis direction and into the size Bd in the d-axis direction, and is represented by the partitioned weights w (i,j, co, do). In the explanation below, a weight w that has been partitioned will also referred to as a “partitioned weight w”.

The output data f(x, y, do) partitioned into the size Bd is determined by Equation 9. The final output data f(x, y, d) can be computed by combining the partitioned output data f(x, y, do).

$$\begin{matrix}f \left(x , y , d o\right) = \\ {\sum }_{i}^{K} {\sum }_{j}^{K} {\sum }_{c o}^{C / B c} a \left(s ⋅ x + i , s ⋅ y + j , c o\right) ⋅ w \left(i , j , c o , d o\right)\end{matrix} \qquad \text{[Equation 9]}$$

### [Expansion of Convolution Operation Data]

The NN circuit 100 performs convolution operations by expanding the input data a and the weights w in the convolution operations by the convolution layers 210.

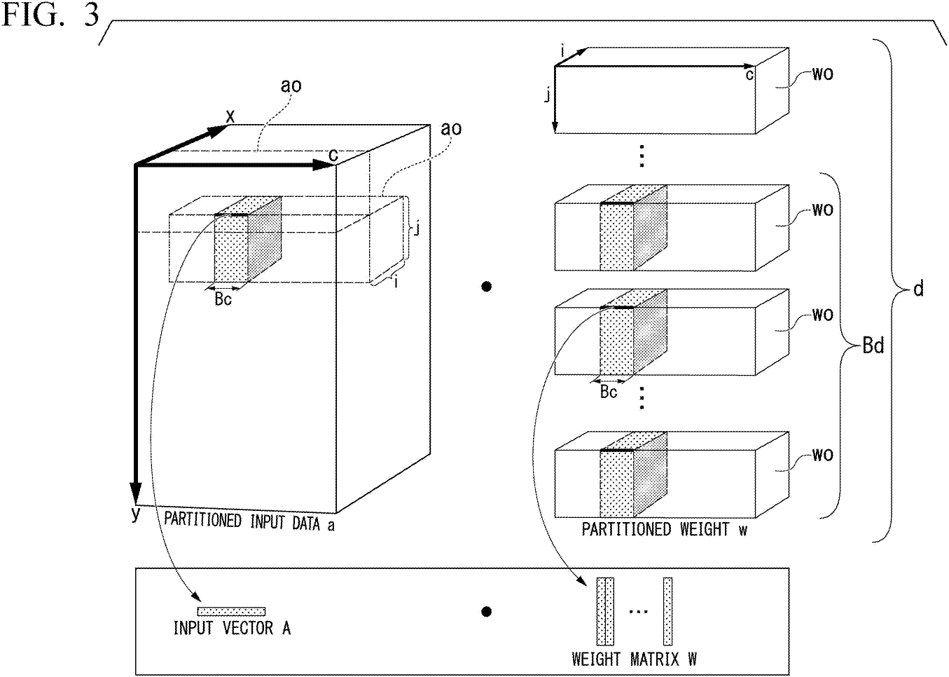

FIG. 3 is a diagram explaining the expansion of the convolution operation data.

The partitioned input data a(x + i, y + j, co) is expanded into vector data having Bc elements. The elements in the partitioned input data a are indexed by ci (where 0 ≤ ci < Bc). In the explanation below, partitioned input data a expanded into vector data for each of i and j will also be referred to as “input vector A”. An input vector A has elements from partitioned input data a(x + i, y + j, co × Bc) to partitioned input data a(x + i, y + j, co × Bc + (Bc - 1)).

The partitioned weights w(i, j, co, do) are expanded into matrix data having Bc × Bd elements. The elements of the partitioned weights w expanded into matrix data are indexed by ci and di (where 0 ≤ di < Bd). In the explanation below, a partitioned weight w expanded into matrix data for each of i and j will also be referred to as a “weight matrix W”. A weight matrix W has elements from a partitioned weight w(i, j, co × Bc, do × Bd) to a partitioned weight w(i, j, co × Bc + (Bc - 1), do × Bd + (Bd - 1)).

Vector data is computed by multiplying an input vector A with a weight matrix W. Output data f(x, y, do) can be obtained by formatting vector data computed for each of i, j, and co as a three-dimensional tensor. By expanding data in this manner, the convolution operations in the convolution layers 210 can be implemented by multiplying vector data with matrix data.

### [NN Circuit 100]

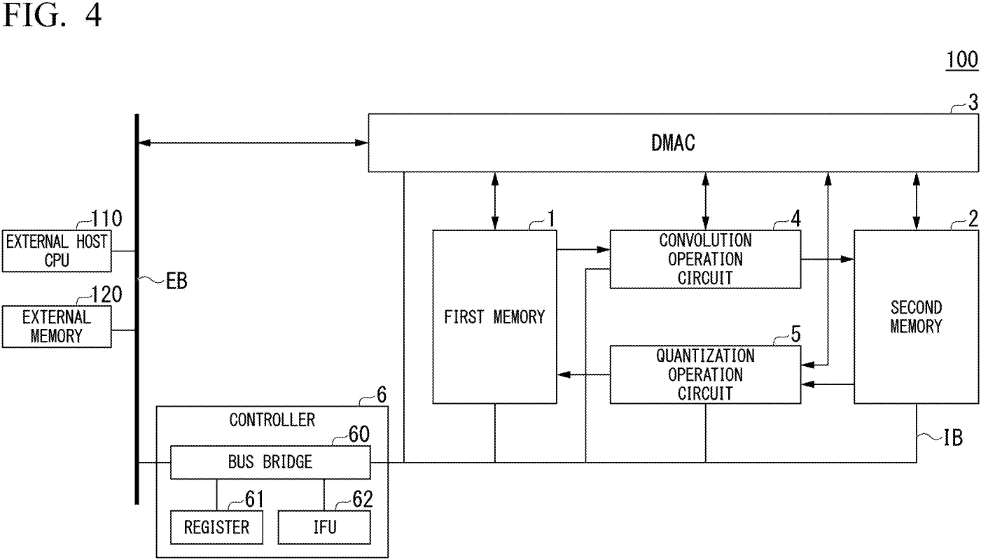

FIG. 4 is a diagram illustrating the overall structure of the NN circuit 100 according to the present embodiment.

The NN circuit 100 is provided with a first memory 1, a second memory 2, a DMA controller 3 (hereinafter also referred to as “DMAC 3”), a convolution operation circuit 4, a quantization operation circuit 5, and a controller 6. The NN circuit 100 is characterized in that the convolution operation circuit 4 and the quantization operation circuit 5 form a loop with the first memory 1 and the second memory 2 therebetween.

The NN circuit 100 is connected, by an external bus EB, to an external host CPU 110 and an external memory 120. The external host CPU 110 includes a general-purpose CPU. The external memory 120 includes memory such as a DRAM and a control circuit for the same. A program executed by the external host CPU 110 and various types of data are stored in the external memory 120. The external bus EB connects the external host CPU 110 and the external memory 120 with the NN circuit 100.

The first memory 1 is a rewritable memory such as a volatile memory composed, for example, of SRAM (Static RAM) or the like. Data is written into and read from the first memory 1 via the DMAC 3 and the controller 6. The first memory 1 is connected to an input port of the convolution operation circuit 4, and the convolution operation circuit 4 can read data from the first memory 1. Additionally, the first memory 1 is connected to an output port of the quantization operation circuit 5, and the quantization operation circuit 5 can write data into the first memory 1. The external host CPU 110 can input and output data with respect to the NN circuit 100 by writing and reading data with respect to the first memory 1.

The second memory 2 is a rewritable memory such as a volatile memory composed, for example, of SRAM (Static RAM) or the like. Data is written into and read from the second memory 2 via the DMAC 3 and the controller 6. The second memory 2 is connected to an input port of the quantization operation circuit 5, and the quantization operation circuit 5 can read data from the second memory 2. Additionally, the second memory 2 is connected to an output port of the convolution operation circuit 4, and the convolution operation circuit 4 can write data into the second memory 2. The external host CPU 110 can input and output data with respect to the NN circuit 100 by writing and reading data with respect to the second memory 2.

The DMAC 3 is connected to an external bus EB and transfers data between the external memory 120 and the first memory 1. Additionally, the DMAC 3 transfers data between the external memory 120 and the second memory 2. Additionally, the DMAC 3 transfers data between the external memory 120 and the convolution operation circuit 4. Additionally, the DMAC 3 transfers data between the external memory 120 and the quantization operation circuit 5.

The convolution operation circuit 4 is a circuit that performs a convolution operation in a convolution layer 210 in the trained CNN 200. The convolution operation circuit 4 reads input data a stored in the first memory 1 and implements a convolution operation on the input data a. The convolution operation circuit 4 writes output data ƒ (hereinafter also referred to as “convolution operation output data”) from the convolution operation into the second memory 2.

The quantization operation circuit 5 is a circuit that performs at least part of a quantization operation in a quantization operation layer 220 in the trained CNN 200. The quantization operation circuit 5 reads the output data f from the convolution operation stored in the second memory 2, and performs a quantization operation (among pooling, batch normalization, an activation function, and quantization, operations including at least quantization) on the output data f from the convolution operation. The quantization operation circuit 5 writes the output data (hereinafter referred to as “quantization operation output data”) from the quantization operation into the first memory 1.

The controller 6 is connected to the external bus EB and operates as a master and a slave to the external bust EB. The controller 6 has a bus bridge 60, a register 61, and an IFU 62.

The register 61 has a parameter register or a state register. The parameter register is a register for controlling operations of the NN circuit 100. The state register is a register indicating the state of the NN circuit 100 including semaphores S. The external host CPU 110 can access the register 61 via the bus bridge 60 in the controller 6.

The IFU (Instruction Fetch Unit) 62, based on instructions from the external host CPU 110, reads from the external memory 120, via the external bus EB, commands for the DMAC 3, the convolution operation circuit 4, and the quantization operation circuit 5. Additionally, the IFU 62 transfers the commands that have been read out to the corresponding DMAC 3, convolution operation circuit 4, and quantization operation circuit 5.

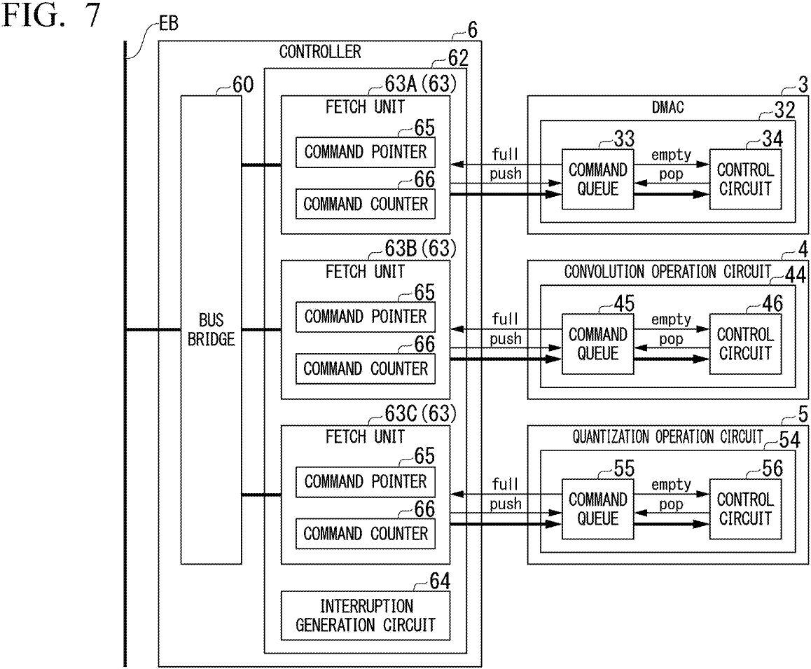

The controller 6 is connected, via an internal bus IB (see FIG. 4) and dedicated wiring (see FIG. 7) that is connected to the IFU 62, to the first memory 1, the second memory 2, the DMAC 3, the convolution operation circuit 4, and the quantization operation circuit 5. The external host CPU 110 can access each block via the controller 6. For example, the external host CPU 110 can issue commands to the DMAC 3, the convolution operation circuit 4, and the quantization operation circuit 5 via the controller 6.

The DMAC 3, the convolution operation circuit 4, and the quantization operation circuit 5 can update the state register (including the semaphores S) in the controller 6 via the internal bus IB. The state register (including the semaphores S) may be configured to be updated via dedicated wiring connected to the DMAC 3, the convolution operation circuit 4, or the quantization operation circuit 5.

Since the NN circuit 100 has a first memory 1, a second memory 2, and the like, the number of data transfers of redundant data can be reduced in data transfers by the DMAC 3 from the external memory 120. As a result thereof, the power consumption that occurs due to memory access can be largely reduced.

### [Operational Example 1 of NN Circuit 100]

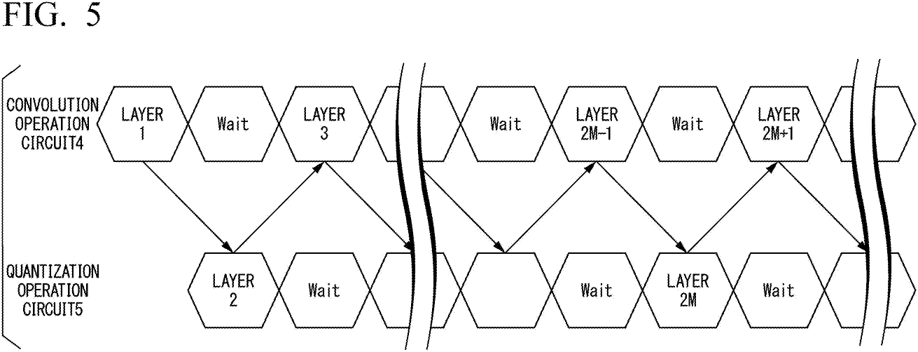

FIG. 5 is a timing chart indicating an operational example of the NN circuit 100.

The DMAC 3 stores layer-1 input data a in a first memory 1. The DMAC 3 may transfer the layer-1 input data a to the first memory 1 in a partitioned manner, in accordance with the sequence of convolution operations performed by the convolution operation circuit 4.

The convolution operation circuit 4 reads the layer-1 input data a stored in the first memory 1. The convolution operation circuit 4 performs the layer-1 convolution operation illustrated in FIG. 1 on the layer-1 input data a. The output data f from the layer-1 convolution operation is stored in the second memory 2.

The quantization operation circuit 5 reads the layer-1 output data f stored in the second memory 2. The quantization operation circuit 5 performs a layer-2 quantization operation on the layer-1 output data f. The output data from the layer-2 quantization operation is stored in the first memory 1.

The convolution operation circuit 4 reads the layer-2 quantization operation output data stored in the first memory 1. The convolution operation circuit 4 performs a layer-3 convolution operation using the output data from the layer-2 quantization operation as the input data a. The output data f from the layer-3 convolution operation is stored in the second memory 2.

The convolution operation circuit 4 reads layer-(2M - 2) (M being a natural number) quantization operation output data stored in the first memory 1. The convolution operation circuit 4 performs a layer-(2M - 1) convolution operation with the output data from the layer-(2M - 2) quantization operation as the input data a. The output data f from the layer-(2M - 1) convolution operation is stored in the second memory 2.

The quantization operation circuit 5 reads the layer-(2M - 1) output data f stored in the second memory 2. The quantization operation circuit 5 performs a layer-2M quantization operation on the layer-(2M - 1) output data f. The output data from the layer-2M quantization operation is stored in the first memory 1.

The convolution operation circuit 4 reads the layer-2M quantization operation output data stored in the first memory 1. The convolution operation circuit 4 performs a layer-(2M + 1) convolution operation with the layer-2M quantization operation output data as the input data a. The output data f from the layer-(2M + 1) convolution operation is stored in the second memory 2.

The convolution operation circuit 4 and the quantization operation circuit 5 perform operations in an alternating manner, thereby carrying out the operations of the CNN 200 indicated in FIG. 1. In the NN circuit 100, the convolution operation circuit 4 implements the layer-(2M - 1) convolution operations and the layer-(2M + 1) convolution operations in a time-divided manner. Additionally, in the NN circuit 100, the quantization operation circuit 5 implements the layer-(2M - 2) quantization operations and the layer-2M quantization operations in a time-divided manner. Therefore, in the NN circuit 100, the circuit size is extremely small in comparison to the case in which a convolution operation circuit 4 and a quantization operation circuit 5 are installed separately for each layer.

In the NN circuit 100, the operations of the CNN 200, which has a multilayered structure with multiple layers, are performed by circuits that form a loop. The NN circuit 100 can efficiently utilize hardware resources due to the looped circuit configuration. Since the NN circuit 100 has circuits forming a loop, the parameters in the convolution operation circuit 4 and the quantization operation circuit 5, which change in each layer, are appropriately updated.

If the operations in the CNN 200 include operations that cannot be implemented by the NN circuit 100, then the NN circuit 100 transfers intermediate data to an external operation device such as an external host CPU 110. After the external operation device has performed the operations on the intermediate data, the operation results from the external operation device are input to the first memory 1 and the second memory 2. The NN circuit 100 resumes operations on the operation results from the external operation device.

### [Operational Example 2 of NN Circuit 100]

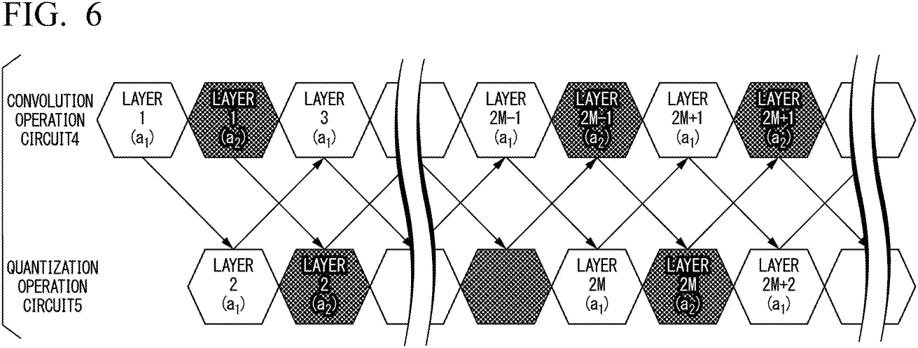

FIG. 6 is a timing chart illustrating another operational example of the NN circuit 100.

The NN circuit 100 may partition the input data a into partial tensors, and may perform operations on the partial tensors in a time-divided manner. The partitioning method and the number of partitions of the partial tensors are not particularly limited.

FIG. 6 shows an operational example for the case in which the input data a is decomposed into two partial tensors. The decomposed partial tensors are referred to as “first partial tensor a₁” and “second partial tensor a₂”. For example, the layer-(2M - 1) convolution operation is decomposed into a convolution operation corresponding to the first partial tensor a₁ (in FIG. 6, indicated by “Layer 2M - 1 (a₁)”) and a convolution operation corresponding to the second partial tensor a₂ (in FIG. 6, indicated by “Layer 2M - 1 (a₂)”).

The convolution operations and the quantization operations corresponding to the first partial tensor a₁ can be implemented independently of the convolution operations and the quantization operations corresponding to the second partial tensor a₂, as illustrated in FIG. 6.

The convolution operation circuit 4 performs a layer-(2M - 1) convolution operation corresponding to the first partial tensor a₁ (in FIG. 6, the operation indicated by layer 2M - 1 (a₁)). Thereafter, the convolution operation circuit 4 performs a layer-(2M -1) convolution operation corresponding to the second partial tensor a₂ (in FIG. 6, the operation indicated by layer 2M - 1 (a₂)). Additionally, the quantization operation circuit 5 performs a layer-2M quantization operation corresponding to the first partial tensor a₁ (in FIG. 6, the operation indicated by layer 2M (a₁)). Thus, the NN circuit 100 can implement the layer-(2M - 1) convolution operation corresponding to the second partial tensor a₂ and the layer-2M quantization operation corresponding to the first partial tensor a₁ in parallel.

Next, the convolution operation circuit 4 performs a layer-(2M + 1) convolution operation corresponding to the first partial tensor a₁ (in FIG. 6, the operation indicated by layer 2M + 1 (a₁)). Additionally, the quantization operation circuit 5 performs a layer-2M quantization operation corresponding to the second partial tensor a₂ (in FIG. 6, the operation indicated by layer 2M (a₂)). Thus, the NN circuit 100 can implement the layer-(2M + 1) convolution operation corresponding to the first partial tensor a₁ and the layer-2M quantization operation corresponding to the second partial tensor a₂ in parallel.

By partitioning the input data a into partial tensors, the NN circuit 100 can make the convolution operation circuit 4 and the quantization operation circuit 5 operate in parallel. As a result thereof, the time during which the convolution operation circuit 4 and the quantization operation circuit 5 are idle can be reduced, thereby increasing the operation processing efficiency of the NN circuit 100. Although the number of partitions in the operational example indicated in FIG. 6 was two, the NN circuit 100 can similarly make the convolution operation circuit 4 and the quantization operation circuit 5 operate in parallel even in cases in which the number of partitions is greater than two.

Regarding the operation method for the partial tensors, an example in which partial tensor operations in the same layer are performed by the convolution operation circuit 4 or the quantization operation circuit 5, then followed by partial tensor operations in the next layer (method 1) was described. For example, as indicated in FIG. 6, in the convolution operation circuit 4, after the layer-(2M - 1) convolution operations corresponding to the first partial tensor a₁ and the second partial tensor a₂ (in FIG. 6, the operations indicated by layer 2M - 1 (a₁) and layer 2M - 1 (a₂)) are performed, the layer-(2M + 1) convolution operations corresponding to the first partial tensor a₁ and the second partial tensor a₂ (in FIG. 6, the operations indicated by layer 2M + 1 (a₁) and layer 2M + 1 (a₂)) are implemented.

However, the operation method for the partial tensors is not limited thereto. The operation method for the partial tensors may be a method wherein operations on some of the partial tensors in multiple layers are followed by implementation of operations on the remaining partial tensors (method 2). For example, in the convolution operation circuit 4, after the layer-(2M - 1) convolution operations corresponding to the first partial tensor a₁ and the layer-(2M + 1) convolution operations corresponding to the first partial tensor a₁ are performed, the layer-(2M - 1) convolution operations corresponding to the second partial tensor a₂ and the layer-(2M + 1) convolution operations corresponding to the second partial tensor a₂ may be implemented.

Additionally, the operation method for the partial tensors may be a method that involves performing operations on the partial tensors by combining method 1 and method 2. However, in the case in which method 2 is used, the operations must be implemented in accordance with a dependence relationship relating to the operation sequence of the partial tensors.

Next, the respective features of the NN circuit 100 will be explained in detail. FIG. 7 is a diagram illustrating the dedicated wiring connecting the IFU 62 of the controller 6 with the DMAC 3, etc.

### [DMAC 3]

The DMAC 3 has a data transfer circuit (not illustrated) and a state controller 32. The DMAC 3 has a state controller 32 that is dedicated to the data transfer circuit, so that when a command C3 is input therein, DMA data transfer can be implemented without requiring an external controller.

The state controller 32 controls the state of the data transfer circuit. Additionally, the state controller 32 is connected to the controller 6 by the internal bus IB (see FIG. 4) and dedicated wiring (see FIG. 7) connected to the IFU 62. The state controller 32 has a command queue 33 and a control circuit 34.

The command queue 33 is a queue in which commands (third commands) C3 for the DMAC 3 are stored, and is constituted, for example, by an FIFO memory. One or more commands C3 are written into the command queue 33 via the internal bus IB or the IFU 62.

The command queue 33 outputs “empty” flags indicating that the number of stored commands C3 is “0”, and “full” flags indicating that the number of stored commands C3 is a maximum value. The command queue 33 may output “half empty” flags or the like indicating that the number of stored commands C3 is less than or equal to half the maximum value.

The “empty” flags or “full” flags for the command queue 33 are stored as a state register in the register 61. The external host CPU 110 can check the state of the flags, such as “empty” flags or “full” flags, by reading them from the state register in the register 61.

The control circuit 34 is a state machine that decodes the commands C3 and that controls the data transfer circuit based on the commands C3. The control circuit 34 may be implemented by a logic circuit, or may be implemented by a CPU controlled by software.

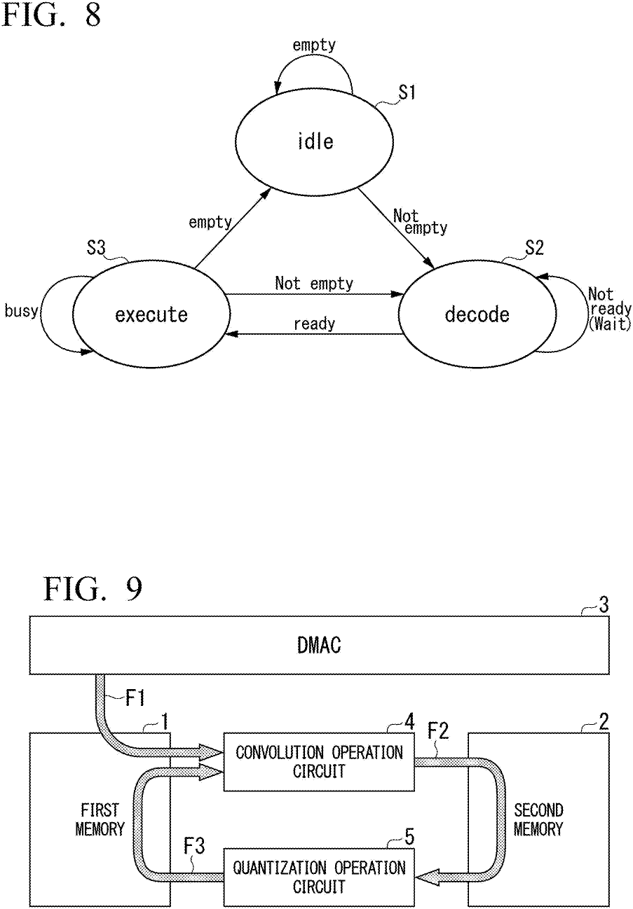

FIG. 8 is a state transition diagram of the control circuit 34.

The control circuit 34 transitions from an idle state S1 to a decoding state S2 upon detecting, based on an “empty” flag in the command queue 33, that a command C3 has been input to the command queue 33 (Not empty).

In the decoding state S2, the control circuit 34 decodes commands C3 output from the command queue 33. Additionally, the control circuit 34 reads semaphores S stored in the register 61 in the controller 6, and determines whether or not the operations of the data transfer circuit instructed by the commands C3 can be executed. If a command cannot be executed (Not ready), then the control circuit 34 waits (Wait) until the command can be executed. If the command can be executed (ready), then the control circuit 34 transitions from the decoding state S2 to an execution state S3.

In the execution state S3, the control circuit 34 controls the data transfer circuit and makes the data transfer circuit carry out operations instructed by the command C3. When the operations in the data transfer circuit end, the control circuit 34 sends a pop command to the command queue 33, removes the command C3 that has finished being executed from the command queue 33 and updates the semaphores S stored in the register 61 in the controller 6. If a command is detected in the command queue 33 (Not empty) based on the “empty” flag in the command queue 33, then the control circuit 34 transitions from the execution state S3 to the decoding state S2. If no commands are detected in the command queue 33 (empty), then the control circuit 34 transitions from the execution state S3 to the idle state S1.

### [Convolution Operation Circuit 4]

The convolution operation circuit 4 has operation circuits (not illustrated), such as a multiplier, and a state controller 44. The convolution operation circuit 4 has a state controller 44 that is dedicated to the operation circuits, etc., such as the multiplier 42, so that when a command C4 is input, a convolution operation can be implemented without requiring an external controller.

The state controller 44 controls the states of the operation circuits such as the multiplier. Additionally, the state controller 44 is connected to the controller 6 via the internal bus IB (see FIG. 4) and dedicated wiring (see FIG. 7) connected to the IFU 62. The state controller 44 has a command queue 45 and a control circuit 46.

The command queue 45 is a queue in which commands (first commands) C4 for the convolution operation circuit 4 are stored, and is constituted, for example, by an FIFO memory. The commands C4 are written into the command queue 45 via the internal bus IB or the IFU 62. The command queue 45 has a configuration similar to that of the command queue 33 in the state controller 32 in the DMAC 3.

The control circuit 46 is a state machine that decodes the commands C4 and that controls the operation circuit, such as the multiplier, based on the commands C4. The control circuit 46 has a configuration similar to that of the control circuit 34 in the state controller 32 in the DMAC 3.

### [Quantization Operation Circuit 5]

The quantization operation circuit 5 has a quantization circuit, etc., and a state controller 54. The quantization operation circuit 5 has a state controller 54 that is dedicated to the quantization circuit, etc., so that when a command C5 is input, a quantization operation can be implemented without requiring an external controller.

The state controller 54 controls the states of the quantization circuit, etc. Additionally, the state controller 54 is connected to the controller 6 via the internal bus IB (see FIG. 4) and dedicated wiring (see FIG. 7) connected to the IFU 62. The state controller 54 has a command queue 55 and a control circuit 56.

The command queue 55 is a queue in which commands (second commands) C5 for the quantization operation circuit 5 are stored, and is constituted, for example, by an FIFO memory. The commands C5 are written into the command queue 55 via the internal bus IB or the IFU 62. The command queue 55 has a configuration similar to that of the command queue 33 in the state controller 32 in the DMAC 3.

The control circuit 56 is a state machine that decodes the commands C5 and that controls the quantization circuit, etc. based on the commands C5. The control circuit 56 has a configuration similar to that of the control circuit 34 in the state controller 32 in the DMAC 3.

### [Controller 6]

The controller 6 is connected to the external bus EB and operates as a master and a slave to the external bus EB. The controller 6 has a bus bridge 60, a register 61 including a parameter register and a state register, and an IFU 62. The parameter register is a register for controlling the operations of the NN circuit 100. The state register is a register indicating the state of the NN circuit 100 and including semaphores S.

The bus bridge 60 relays bus access from the external bus EB to the internal bus IB. Additionally, the bus bridge 60 relays write requests and read requests from the external host CPU 110 to the register 61. Additionally, the bus bridge 60 relays read requests from the IFU 62 to the external memory 120 through the external bus EB.

In the case in which the NN circuit 100, the external host CPU 110 and the external memory 120 are integrated on the same silicon chip, the external bus EB is an interconnect in accordance with standard specifications such as, for example, AXI (registered trademark). In the case in which at least one of the NN circuit 100, the external host CPU 110 and the external memory 120 is integrated on a different silicon chip, the external bus EB is an interconnect in accordance with standard specifications such as, for example, PCI-Express (registered trademark). The bus bridge 60 has a protocol conversion circuit supporting the specifications of the external bus EB that is connected. In the case in which the external host CPU 110 or the external memory 120 is integrated on a silicon chip different from the NN circuit 100, a buffer for temporarily holding a prescribed quantity of commands may be provided on the same silicon chip as the NN circuit 100 in order to suppress decreases in the overall computation rate due to the communication rate.

The controller 6 transfers commands to the command queues in the DMAC 3, the convolution operation circuit 4, and the quantization operation circuit 5 by two methods. The first method is a method for transferring commands transferred from the external host CPU 110 to the controller 6 via the internal bus IB (see FIG. 4). The second method is a method in which the IFU 62 reads commands from the external memory 120 and transfers the commands to the dedicated wiring (see FIG. 7) connected to the IFU 62.

The IFU (Instruction Fetch Unit) 62, as illustrated in FIG. 7, has multiple fetch units 63 and an interruption generation circuit 64.

The fetch units 63 read commands from the external memory 120 via the external bus EB based on instructions from the external host CPU 110. Additionally, the fetch units 63 supply the commands that have been read out to the command queues in the corresponding DMAC 3, etc.

The fetch units 63 each have a command pointer 65 and a command counter 66. The external host CPU 110 can implement writing and reading with respect to the command pointers 65 and the command counters 66 via the external bus EB.

The command pointers 65 hold the memory addresses at which the commands are stored in the external host CPU 110. The command counters 66 hold command counts of the stored commands. The command counters 66 are initialized to “0”. The fetch units 63 are activated by the external host CPU 110 writing a value equal to or greater than “1” into the command counters 66. The fetch units 63 reference the command pointers 65 and read the commands from the external memory 120. In this case, the controller 6 operates as a master with respect to the external bus EB.

The fetch units 63 update the command pointers 65 and the command counters 66 each time the commands are read out. The command counters 66 are decremented each time a command is read out. The fetch units 63 read out commands until the command counters 66 become “0”.

The fetch units 63 send “push” commands to the command queues of the corresponding DMAC 3, etc., and write commands that have been read out into the command queues of the corresponding DMAC 3, etc. However, if a “full” flag of a command queue is equal to “1 (true)”, then the fetch units 63 will not write commands into the command queuer until the “full” flag becomes equal to “0 (false)”.

The fetch units 63 can efficiently read out commands via the external bus EB by referencing the flags of the command queues and the command counters 66, and using burst transfer as needed.

The fetch units 63 are provided for each command queue. In the description hereinafter, the fetch unit 63 for use by the command queue 33 of the DMAC 3 will be referred to as the “fetch unit 63A (third fetch unit)”, the fetch unit 63 for use by the command queue 45 of the convolution operation circuit 4 will be referred to as the “fetch unit 63B (first fetch unit)”, and the fetch unit 63 for use by the command queue 55 of the quantization operation circuit 5 will be referred to as the “fetch unit 63C (second fetch unit)”.

The reading of commands via the external bus EB by the fetch unit 63A, the fetch unit 63B, and the fetch unit 63C is mediated by the bus bridge 60 based on, for example, round-robin priority level control.

The interruption generation circuit 64 monitors the command counters 66 of the fetch units 63, and when the command counters 66 in all of the fetch units 63 become “0”, causes an interruption of the external host CPU 110. The external host CPU 110 can detect that the readout of commands by the IFU 62 has been completed by means of the above-mentioned interruption, without polling the state register in the register 61.

### [Semaphores S]

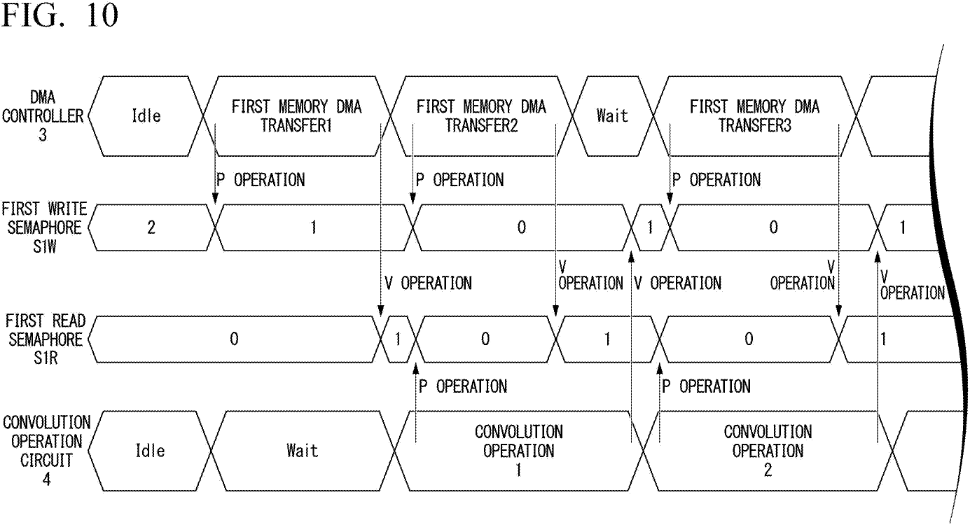

FIG. 9 is a diagram explaining the control of the NN circuit 100 by semaphores S.

The semaphores S include first semaphores S1, second semaphores S2, and third semaphores S3. The semaphores S are decremented by P operations and incremented by V operations. P operations and V operations by the DMAC 3, the convolution operation circuit 4, and the quantization operation circuit 5 update the semaphores S in the controller 6 via the internal bus IB.

The first semaphores S1 are used to control the first data flow F1. The first data flow F1 is data flow by which the DMAC 3 (Producer) writes input data a into the first memory 1 and the convolution operation circuit 4 (Consumer) reads the input data a. The first semaphores S1 include a first write semaphore S1W and a first read semaphore S1R.

The second semaphores S2 are used to control the second data flow F2. The second data flow F2 is data flow by which the convolution operation circuit 4 (Producer) writes output data f into the second memory 2 and the quantization operation circuit 5 (Consumer) reads the output data f. The second semaphores S2 include a second write semaphore S2W and a second read semaphore S2R.

The third semaphores S3 are used to control the third data flow F3. The third data flow F3 is data flow by which the quantization operation circuit 5 (Producer) writes quantization operation output data into the first memory 1 and the convolution operation circuit 4 (Consumer) reads the quantization operation output data from the quantization operation circuit 5. The third semaphores S3 include a third write semaphore S3W and a third read semaphore S3R.

### [First Data Flow F1]

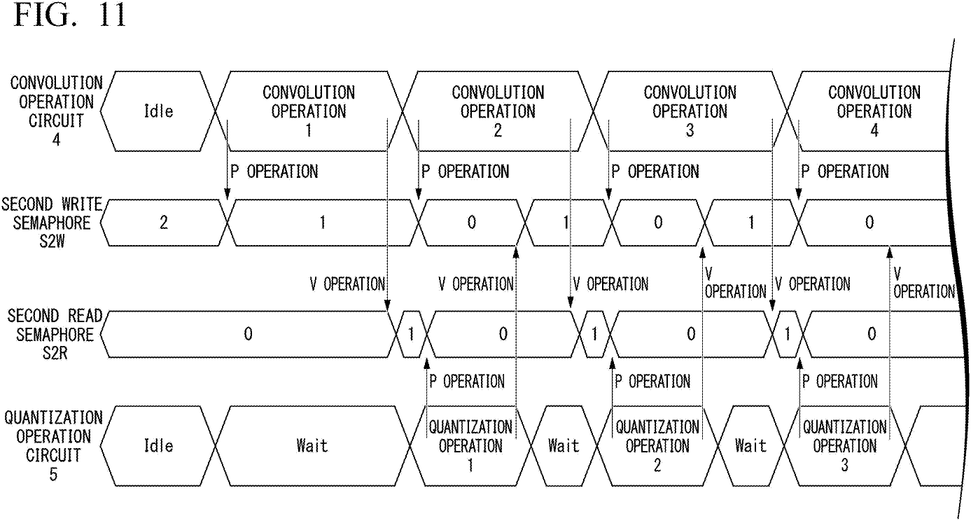

FIG. 10 is a timing chart of first data flow F1.

The first write semaphore S1W is a semaphore that restricts writing into the first memory 1 by the DMAC 3 in the first data flow F1. The first write semaphore S1W indicates, for example, among the memory areas in the first memory 1 in which data of a prescribed size, such as that of an input vector A, can be stored, and the number of memory areas from which data has been read and into which other data can be written. If the first write semaphore S1W is equal to “0”, then the DMAC 3 cannot perform the writing in the first data flow F1 with respect to the first memory 1, and the DMAC 3 must wait until the first write semaphore S1W becomes at least “1”.

The first read semaphore S1R is a semaphore that restricts reading from the first memory 1 by the convolution operation circuit 4 in the first data flow F1. The first read semaphore S1R indicates, for example, among the memory areas in the first memory 1 in which data of a prescribed size, such as that of an input vector A, can be stored, the number of memory areas into which data has been written and can be read. If the first read semaphore S1R is equal to “0”, then the convolution operation circuit 4 cannot perform the reading in the first data flow F1 with respect to the first memory 1, and the convolution operation circuit 4 must wait until the first read semaphore S1R becomes at least “1”.

The DMAC 3 initiates DMA transfer when a command C3 is stored in the command queue 33. As indicated in FIG. 10, the first write semaphore S1W is not equal to “0”. Thus, the DMAC 3 initiates DMA transfer (DMA transfer 1). The DMAC 3 performs a P operation on the first write semaphore S1W when the DMA transfer is initiated. After the DMA transfer instructed by the command C3 has been completed, the DMAC 3 sends a “pop” command to the command queue 33, removes the command C3 that has finished being executed from the command queue 33, and performs a V operation on the first read semaphore S1R.

The convolution operation circuit 4 initiates a convolution operation when a command C4 is stored in the command queue 45. As indicated in FIG. 10, the first read semaphore S1R is equal to “0”. Thus, the convolution operation circuit 4 must wait until the first read semaphore S1R becomes at least “1” (“Wait” in the decoding state S2). When the DMAC 3 performs a V operation and thus the first read semaphore S1R becomes equal to “1”, the convolution operation circuit 4 initiates a convolution operation (convolution operation 1). The convolution operation circuit 4 performs a P operation on the first read semaphore S1R when initiating the convolution operation. After the convolution operation instructed by the command C4 has been completed, the convolution operation circuit 4 sends a “pop” command to the command queue 45, removes the command C4 that has finished being executed from the command queue 45, and performs a V operation on the first write semaphore S1W.

The state controller 44 in the convolution operation circuit 4, upon detecting that the next command is in the command queue 45 (Not empty) based on the “empty” flag of the command queue 45, transitions from the execution state S3 to the decoding state S2.

When the DMAC 3 initiates the DMA transfer indicated as the “DMA transfer 3” in FIG. 10, the first write semaphore S1W is equal to “0”. Thus, the DMAC 3 must wait until the first write semaphore S1W becomes at least “1” (“Wait” in the decoding state S2). When the convolution operation circuit 4 performs a V operation and thus the first write semaphore S1W becomes at least “1”, the DMAC 3 initiates the DMA transfer.

The DMAC 3 and the convolution operation circuit 4 can prevent competition for access to the first memory 1 in the first data flow F1 by using the semaphores S1. Additionally, the DMAC 3 and the convolution operation circuit 4 can operate independently and in parallel while synchronizing data transfer in the first data flow F1 by using the semaphores S1.

### [Second Data Flow F2]

FIG. 11 is a timing chart of second data flow F2.

The second write semaphore S2W is a semaphore that restricts writing into the second memory 2 by the convolution operation circuit 4 in the second data flow F2. The second write semaphore S2W indicates, for example, among the memory areas in the second memory 2 in which data of a prescribed size, such as that of output data f, can be stored, the number of memory areas from which data has been read and into which other data can be written. If the second write semaphore S2W is equal to “0”, then the convolution operation circuit 4 cannot perform the writing in the second data flow F2 with respect to the second memory 2, and the convolution operation circuit 4 must wait until the second write semaphore S2W becomes at least “1”.

The second read semaphore S2R is a semaphore that restricts reading from the second memory 2 by the quantization operation circuit 5 in the second data flow F2. The second read semaphore S2R indicates, for example, among the memory areas in the second memory 2 in which data of a prescribed size, such as that of output data f, can be stored, the number of memory areas into which data has been written and can be read out. If the second read semaphore S2R is equal to “0”, then the quantization operation circuit 5 cannot perform the reading in the second data flow F2 with respect to the second memory 2, and the quantization operation circuit 5 must wait until the second read semaphore S2R becomes at least “1”.

As indicated in FIG. 11, the convolution operation circuit 4 performs a P operation on the second write semaphore S2W when the convolution operation is initiated. After the convolution operation instructed by the command C4 has been completed, the convolution operation circuit 4 sends a “pop” command to the command queue 45, removes the command C4 that has finished being executed from the command queue 45, and performs a V operation on the second read semaphore S2R.

The quantization operation circuit 5 initiates a quantization operation when a command C5 is stored in the command queue 55. As indicated in FIG. 11, the second read semaphore S2R is equal to “0”. Thus, the quantization operation circuit 5 must wait until the second read semaphore S2R becomes at least “1” (“Wait” in the decoding state S2). When the convolution operation circuit 4 performs a V operation and thus the second read semaphore S2R becomes equal to “1”, the quantization operation circuit 5 initiates the quantization operation (quantization operation 1). The quantization operation circuit 5 performs a P operation on the second read semaphore S2R when initiating the quantization operation. After the quantization operation instructed by the command C5 has been completed, the quantization operation circuit 5 sends a “pop” command to the command queue 55, removes the command C5 that has finished being executed from the command queue 55, and performs a V operation on the second write semaphore S2W.

The state controller 54 in the quantization operation circuit 5, upon detecting that the next command is in the command queue 55 (Not empty) based on the “empty” flag of the command queue 55, transitions from the execution state S3 to the decoding state S2.

When the quantization operation circuit 5 initiates the quantization operation indicated as the “quantization operation 2” in FIG. 11, the second read semaphore S2R is equal to “0”. Thus, the quantization operation circuit 5 must wait until the second read semaphore S2R becomes at least “1” (“Wait” in the decoding state S2). When the convolution operation circuit 4 performs a V operation and thus the second read semaphore S2R becomes at least “1”, the quantization operation circuit 5 initiates the quantization operation.

The convolution operation circuit 4 and the quantization operation circuit 5 can prevent competition for access to the second memory 2 in the second data flow F2 by using the semaphores S2. Additionally, the convolution operation circuit 4 and the quantization operation circuit 5 can operate independently and in parallel while synchronizing data transfer in the second data flow F2 by using the semaphores S2.

### [Third Data Flow F3]

The third write semaphore S3W is a semaphore that restricts writing into the first memory 1 by the quantization operation circuit 5 in the third data flow F3. The third write semaphore S3W indicates, for example, among the memory areas in the first memory 1 in which data of a prescribed size, such as that of quantization operation output data from the quantization operation circuit 5, can be stored, the number of memory areas from which data has been read and into which other data can be written. If the third write semaphore S3W is equal to “0”, then the quantization operation circuit 5 cannot perform the writing in the third data flow F3 with respect to the first memory 1, and the quantization operation circuit 5 must wait until the third write semaphore S3W becomes at least “1”.

The third read semaphore S3R is a semaphore that restricts reading from the first memory 1 by the convolution operation circuit 4 in the third data flow F3. The third read semaphore S3R indicates, for example, among the memory areas in the first memory 1 in which data of a prescribed size, such as that of quantization operation output data from the quantization operation circuit 5, can be stored, the number of memory areas into which data has been written and can be read out. If the third read semaphore S3R is “0”, then the convolution operation circuit 4 cannot perform the reading in the third data flow F3 with respect to the first memory 1, and the convolution operation circuit 4 must wait until the third read semaphore S3R becomes at least “1”.

The quantization operation circuit 5 and the convolution operation circuit 4 can prevent competition for access to the first memory 1 in the third data flow F3 by using the semaphores S3. Additionally, the quantization operation circuit 5 and the convolution operation circuit 4 can operate independently and in parallel while synchronizing data transfer in the third data flow F3 by using the semaphores S3.

The first memory 1 is shared by the first data flow F1 and the third data flow F3. The NN circuit 100 can synchronize data transfer while distinguishing between the first data flow F1 and the third data flow F3 by providing the first semaphores S1 and the third semaphores S3 separately.

### [Control of NN Circuit 100 Using IFU 62]

The external host CPU stores the commands necessary for the series of operations for implementing the NN circuit 100 in a memory such as the external memory 120. Specifically, the external host CPU stores, in the external memory 120, multiple commands C3 for the DMAC 3, multiple commands C4 for the convolution operation circuit 4, and multiple commands C5 for the quantization operation circuit 5.

In the present embodiment, in order to reduce the circuit scale of the NN circuit 100, an example in which the commands necessary for the series of operations for implementing the NN circuit 100 are stored in the external memory 120 will be described. However, in the case in which higher-speed access to the commands is necessary, a dedicated memory that can store the commands necessary for the series of operations for implementing the NN circuit 100 may be provided within the NN circuit 100.

The external host CPU 110 stores, in the command pointer 65 in the fetch unit 63A, the lead address in the external memory 120 at which the commands C3 are stored. Additionally, the external host CPU 110 stores, in the command pointer 65 in the fetch unit 63B, the lead address in the external memory 120 at which the commands C4 are stored. Additionally, the external host CPU 110 stores, in the command pointer 65 in the fetch unit 63C, the lead address in the external memory 120 at which the commands C5 are stored.

The external host CPU 110 sets a command count of the commands C3 in the command counter 66 in the fetch unit 63A. Additionally, the external host CPU 110 sets a command count of the commands C4 in the command counter 66 in the fetch unit 63B. Additionally, the external host CPU 110 sets a command count of the commands C5 in the command counter 66 in the fetch unit 63C.

The IFU 162 reads commands from the external memory 120 and writes the commands that have been read out into the command queues of the corresponding DMAC 3, convolution operation circuit 4, and quantization operation circuit 5.

The DMAC 3, the convolution operation circuit 4, and the quantization operation circuit 5 start operating in parallel based on the commands stored in the command queues. The DMAC 3, the convolution operation circuit 4, and the quantization operation circuit 5 are controlled by the semaphores S, and thus can operate independently and in parallel while synchronizing data transfer. Additionally, the DMAC 3, the convolution operation circuit 4, and the quantization operation circuit 5 are controlled by the semaphores S, and thus can prevent competition for access to the first memory 1 and the second memory 2.

The convolution operation circuit 4, when performing a convolution operation based on a command C4, reads from the first memory 1 and writes into the second memory 2. The convolution operation circuit 4 is a Consumer in the first data flow F1 and is a Producer in the second data flow F2. For this reason, the convolution operation circuit 4, when starting the convolution operation based on the command C4, performs a P operation on the first read semaphore S1R (see FIG. 10) and performs a P operation on the second write semaphore S2W (see FIG. 11). After the convolution operation has been completed, the convolution operation circuit 4 performs a V operation on the first write semaphore S1W (see FIG. 10) and performs a V operation on the second read semaphore S2R (see FIG. 11).

The convolution operation circuit 4, when initiating a convolution operation based on a command C4, must wait (“Wait” in the decoding state S2) until the first read semaphore S1R becomes at least “1” and the second write semaphore S2W becomes at least “1”.

The quantization operation circuit 5, when performing a quantization operation based on a command C5, reads from the second memory 2 and writes into the first memory 1. That is, the quantization operation circuit 5 is a Consumer in the second data flow F2 and is a Producer in the third data flow F3. For this reason, the quantization operation circuit 5, when initiating the quantization operation based on the command C5, performs a P operation on the second read semaphore S2R and performs a P operation on the third write semaphore S3W. After the quantization operation has been completed, the quantization operation circuit 5 performs a V operation on the second write semaphore S2W and performs a V operation on the third read semaphore S3R.

The quantization operation circuit 5, when initiating a quantization operation based on a command C5, must wait (“Wait” in the decoding state S2) until the second read semaphore S2R becomes at least “1” and the third write semaphore S3W becomes at least “1”.

There are cases in which the input data that the convolution operation circuit 4 reads from the first memory 1 is data written by the quantization operation circuit 5 in the third data flow. In this case, the convolution operation circuit 4 is a Consumer in the third data flow F3 and is a Producer in the second data flow F2. For this reason, the convolution operation circuit 4, when initiating a convolution operation based on a command C4, performs a P operation on the third read semaphore S3R and performs a P operation on the second write semaphore S2W. After the convolution operation has been completed, the convolution operation circuit 4 performs a V operation on the third write semaphore S3W and performs a V operation on the second read semaphore S2R.

The convolution operation circuit 4, when initiating a convolution operation based on a command C4, must wait (“Wait” in the decoding state S2) until the third read semaphore S3R becomes at least “1” and the second write semaphore S2W becomes at least “1”.

The IFU 62 can use the interruption generation circuit 64 to generate, in the external host CPU 110, an interruption indicating that the reading of the series of commands by the IFU 62 has been completed. The external host CPU 110, after detecting that the reading of the commands by the IFU 62 has been completed, next stores, in the external memory 120, the commands necessary for the series of operations for implementing the NN circuit 100, and instructs the the IFU 62 to read the next command.

In the case in which the application performing operations using the NN circuit 100 has been changed from a first application to a second application, the external host CPU 110 changes the commands read out by the IFU 62 to commands corresponding to the second application. The change to the commands corresponding to the second application is implemented by a method A for rewriting the commands stored in the external memory 120, a method B for rewriting the command pointers 65 and the command counters 66, or the like. In the case in which method B is used, by storing commands corresponding to the second application in an area of the external memory 120 different from the area in which the commands corresponding to the first application are stored, the commands read out by the IFU 62 can immediately be changed simply by rewriting the command pointers 65 and the command counters 66.

For example, if the applications that perform operations using the NN circuit 100 are object detection applications, then the change from the first application to the second application may occur due to a change in the objects being detected or the like. For example, if the input data to the NN circuit 100 is moving image data, then the change from the first application to the second application may be updated in synchronization with a video synchronization signal.

According to the neural network circuit of the present embodiment, an NN circuit 100 that is embeddable in an embedded device such as an loT device can be operated with high performance. In the NN circuit 100, the DMAC 3, the convolution operation circuit 4, and the quantization operation circuit 5 can operate in parallel. The NN circuit 100, by using the IFU 62, can read commands from the external memory 120 and supply the commands to command queues in corresponding command execution modules (the DMAC 3, the convolution operation circuit 4, and the quantization operation circuit 5). Since the command execution modules are controlled by semaphores S, they can operate independently and in parallel, while also synchronizing data transfer. Additionally, since the command execution modules are controlled by the semaphores S, competition for access to the first memory 1 and the second memory 2 can be prevented. For this reason, the NN circuit 100 can improve the operation processing efficiency of the command execution modules.

While a first embodiment of the present invention has been described in detail with reference to the drawings above, the specific structure is not limited to this embodiment, and design changes or the like within a range not departing from the spirit of the present invention are also included. Additionally, the structural elements indicated in the above embodiment and the modified examples may be combined as appropriate.

### Modified Example 1

In the above embodiment, the first memory 1 and the second memory 2 were separate memories. However, the first memory 1 and the second memory 2 are not limited to such an embodiment. The first memory 1 and the second memory 2 may, for example, be a first memory area and a second memory area in the same memory.

### Modified Example 2

For example, the data input to the NN circuit 100 described in the above embodiment need not be limited to a single form, and may be composed of still images, moving images, audio, text, numerical values, and combinations thereof. The data input to the NN circuit 100 is not limited to being measurement results from a physical amount measuring device such as an optical sensor, a thermometer, a Global Positioning System (GPS) measuring device, an angular velocity measuring device, a wind speed meter, or the like that may be installed in an edge device in which the NN circuit 100 is provided. The data may be combined with different information such as base station information received from a peripheral device by cable or wireless communication, information from vehicles, ships or the like, weather information, peripheral information such as information relating to congestion conditions, financial information, personal information, or the like.

### Modified Example 3

While the edge device in which the NN circuit 100 is provided is contemplated as being a device that is driven by a battery or the like, as in a communication device such as a mobile phone or the like, a smart device such as a personal computer, a digital camera, a game device, or a mobile device in a robot product or the like, the edge device is not limited thereto. Effects not obtained by other prior examples can be obtained by utilization in products for which there is a high demand for long-term driving or for reducing product heat generation, or for restricting the peak electric power that can be supplied by Power on Ethernet (PoE) or the like. For example, by applying the invention to an on-board camera mounted on a vehicle, a ship, or the like, or to a security camera provided in a public facility or on a road, not only can long-term image capture be realized, but also, the invention can contribute to weight reduction and higher durability. Additionally, similar effects can be achieved by applying the invention to a display device on a television, a monitor, or the like, to a medical device such as a medical camera or a surgical robot, or to a working robot or the like used at a production site or at a construction site.

### Modified Example 4

The NN circuit 100 may be realized by using one or more processors for part of or for the entirety of the NN circuit 100. For example, in the NN circuit 100, some or all of the input layer or the output layer may be realized by software processes in a processor. Some of the input layer or the output layer realized by software processes consists, for example, of data normalization and conversion. As a result thereof, the invention can handle various types of input formats or output formats. The software executed by the processor may be configured so as to be rewritable by using communication means or external media.

### Modified Example 5

The NN circuit 100 may be realized by combining some of the processes in the CNN 200 with a Graphics Processing Unit (GPU) or the like on a cloud server. The NN circuit 100 can realize more complicated processes with fewer resources by performing further cloud-based processes in addition to the processes performed by the edge device in which the NN circuit 100 is provided, or by performing processes on the edge device in addition to the cloud-based processes. With such a configuration, the NN circuit 100 can reduce the amount of communication between the edge device and the cloud server by means of processing distribution.

### Modified Example 6

The operations performed by the NN circuit 100 constituted at least part of the trained CNN 200. However, the operations performed by the NN circuit 100 are not limited thereto. The operations performed by the NN circuit 100 may constitute at least part of a trained neural network that repeats two types of operations such as, for example, convolution operations and quantization operations.

Additionally, the effects described in the present specification are merely explanatory or exemplary, and are not limiting. In other words, the features in the present disclosure may, in addition to the effects mentioned above or instead of the effects mentioned above, have other effects that would be clear to a person skilled in the art from the descriptions in the present specification.

### INDUSTRIAL APPLICABILITY

The present invention can be applied to neural network operations.

Reference Signs List

| | |
|---|---|
| 200 | Convolutional neural network |
| 100 | Neural network circuit (NN circuit) |
| 1 | First memory |
| 2 | Second memory |
| 3 | DMA controller (DMAC) |
| 4 | Convolution operation circuit |
| 5 | Quantization operation circuit |
| 6 | Controller |
| 61 | Register |
| 62 | IFU (instruction fetch unit) |
| 63 | Fetch unit |
| 63A | Fetch unit (third fetch unit) |
| 63B | Fetch unit (first fetch unit) |
| 63C | Fetch unit (second fetch unit) |
| 64 | Interruption generation circuit |
| S | Semaphore |
| F1 | First data flow |
| F2 | Second data flow |
| F3 | Third data flow |
| C3 | Command (third command) |
| C4 | Command (first command) |
| C5 | Command (second command) |

1. A neural network circuit comprising:
a convolution operation circuit that performs a convolution operation on input data;
a quantization operation circuit that performs a quantization operation on convolution operation output data from the convolution operation circuit; and
a command fetch unit that reads, from a memory, commands for operating the convolution operation circuit or the quantization operation circuit.

2. The neural network circuit according to claim 1, wherein
the command fetch unit has:
a first fetch unit that reads and supplies, to the convolution operation circuit, the commands for operating the convolution operation circuit; and
a second fetch unit that reads and supplies, to the quantization operation circuit, the commands for operating the quantization operation circuit.

3. The neural network circuit according to claim 1, wherein
the command fetch unit has:
a command pointer that holds memory addresses, in the memory, at which the commands are stored; and
a command counter that holds a command count of the commands that are stored.

4. The neural network circuit according to claim 1, further comprising:
a first memory in which the input data is stored; and
a second memory in which the convolution operation output data is stored; wherein
quantization operation output data from the quantization operation circuit is stored in the first memory; and
the quantization operation output data stored in the first memory is input as the input data to the convolution operation circuit.

5. The neural network circuit according to claim 4, further comprising:
a semaphore for controlling data flow via the first memory and the second memory; wherein
the convolution operation circuit or the quantization operation circuit, when operated based on the commands, performs an operation on the semaphore.

6. A neural network circuit control method for a neural network circuit comprising
a convolution operation circuit that performs a convolution operation on input data,
a quantization operation circuit that performs a quantization operation on convolution operation output data from the convolution operation circuit, and
a command fetch unit that reads, from a memory, commands for operating the convolution operation circuit or the quantization operation circuit,
wherein the neural network circuit control method includes:
a step of making the command fetch unit read the command from the memory and supply the command to the convolution operation circuit or the quantization operation circuit; and
a step of making the convolution operation circuit or the quantization operation circuit operate based on the command that was supplied.

7. The neural network circuit control method according to claim 6, wherein:
the neural network circuit further comprises a semaphore that controls data flow; and
the neural network circuit control method further includes a step of making the convolution operation circuit or the quantization operation circuit that operates based on the command perform an operation on the semaphore.
